(19) United States
(12) Patent Application Publication
(10) Pub. No.: US 2007/0267006 A1
(43) Pub. Date: Nov. 22, 2007

(54) Wire Saw Machine

(76) Inventor: Shingo Ogyu, Saitama (JP)

Correspondence Address: SNIDER & ASSOCIATES, P. O. BOX 27613, WASHINGTON, DC, 20038-7613, US

(21) Appl. No.: 11/587,133

(22) PCT Filed: Oct. 22, 2004
(86) PCT No.: PCT/JP04/15715

§ 371 Date: Jul. 12, 2007

(30) Foreign Application Priority Data
Apr. 30, 2004 (JP) 2004-002434

(51) Int. Cl. B28D 1/08

(52) U.S. Cl. 125/21

(57) ABSTRACT

A wire saw 10 is laid across sheaves 12, 14, 16, and 18 arranged within a substantially horizontal plane. The sheave 12 is rotated by a rotary motor 30 to horizontally drive the wire saw 10. Within a region formed by the wire saw laid across the sheaves, a stone material 80 is set on a carriage 82. The carriage 82 is provided with front wheels 83 and rear wheels 84, and the wheels are set on the pair of rails 85 laid so as to extend in a direction substantially orthogonal to a cutting portion 10A of the wire saw. When the carriage 82 is moved in the direction of the arrow F2 and the stone material 80 is brought into contact with the cutting portion from the inner side of the region formed by the wire saw, the wire saw smoothly bends within the same plane.

### TECHNICAL FIELD

The present invention relates to a wire saw machine using an endless wire saw, more specifically, to a wire saw machine for horizontal cutting of a work.

### BACKGROUND ART

As stone processing machines, there are available processing machines and cutting machines each using a diamond wire saw including diamond beads arranged at proper intervals. For example, Patent Document 1 discloses that a stone material standing still is cut while moving, in the front and rear direction, a stone cutting machine having a gate-shaped main body provided with a number of cutting portions including diamond powder arranged at appropriate intervals and a wire saw to be laterally driven. Patent Document 1: Japanese Published Unexamined Patent Application No. H09-136317 (FIG. 1 and FIG. 4)

### DISCLOSURE OF THE INVENTION

### Problems to be Solved by the Invention

However, in the background art shown in the Patent Document 1, in order to horizontally cut a stone material, as shown in FIG. 1 of the document, it is necessary that the wire saw rotating within a substantially vertical plane is placed on the stone material when cutting the stone material or sheaves on the lower side are rotated around upright axes as shown in FIG. 4 and the stone material is cut by the wire saw laid across the sheaves on the lower side. Therefore, in any case, many portions of the wire bend out of the same plane when cutting. If the number of bends is large, the load on the wire saw increases and the wire saw is easily broken. In the structure of the background art, it is normally necessary to apply a high tension (for example, 200 kg per 1 wire) to the wire, so that the wire is easily damaged.

On the other hand, as a measure for preventing dust scattering due to cutting and preventing the wire from being deteriorated in durability by frictional heat when cutting, water may be supplied to the cutting portion in some cases, however, normally, a method in which water is made to naturally drop from above little by little is employed. This method is effective when the work is vertically cut, however, water hardly soaks into the cutting portion in the case of horizontal cutting. In addition, when one bead of the wire saw passes through, this bead scrapes water out together with the stone material, so that the next (adjacent) bead passes a dry area with no moisture. Therefore, dust is easily produced and the frictional heat becomes high, so that the life of the wire is shortened.

The present invention is made in view of these points, and an object thereof is to provide a wire saw machine which can efficiently cut a work and has excellent durability.

### Means for Solving the Problem

In order to solve the problem, a wire saw machine of the present invention which cuts a work by an endless wire saw, includes a plurality of sheaves for horizontally driving the wire saw, a drive mechanism for driving any of the sheaves, an elevation mechanism for elevating the plurality of sheaves, a tension mechanism for giving necessary tension to the wire saw, rails laid in a direction substantially orthogonal to the driving direction of a cutting portion of the wire saw, a carriage on which a work is set and which is movable on the rails, and a feed mechanism which feeds the carriage so that the work set on the carriage comes into contact with the cutting portion of the wire saw from the inside of a region formed by the wire saw laid across the sheaves.

In addition, the carriage is characterized in that the work can be set thereon in an orientation such that the portion of the work in contact with the cutting portion of the wire saw becomes small. Furthermore, the elevation mechanism includes a pair of column supports stood on an installation surface, a pair of elevation frames provided so as to move up and down with respect to the pair of column supports, a pair of arms which are substantially horizontally fixed, along the rail direction, to the pair of elevation frames and each provided with at least one rotatable sheave, and elevation means for simultaneously elevating the pair of elevation frames.

According to another aspect of the present invention, a wire saw machine which cuts a work by an endless wire saw, includes a plurality of sheaves for horizontally driving the wire saw, a drive mechanism for driving any of the sheaves, a tension mechanism for giving necessary tension to the wire saw, a pair of rails laid in a direction substantially orthogonal to a driving direction of a cutting portion of the wire saw, a pair of column supports movable on the pair of rails, an elevation mechanism for elevating the plurality of sheaves, provided on the pair of column supports, and a feed mechanism which feeds the pair of column supports so that a work set between the pair of rails comes into contact with the cutting portion of the wire saw from the inside of a region formed by the wire saw laid across the plurality of sheaves.

The pair of rails are laid at an interval in which the work can be set in an orientation such that the portion of the work in contact with the cutting portion of the wire saw becomes small. Furthermore, the elevation mechanism includes a pair of elevation frames provided on the pair of column supports, respectively, so as to move up and down, a pair of arms which are substantially fixed horizontally along the rail direction to the pair of elevation frames and each provided with at least one rotatable sheave, and elevation means for simultaneously elevating the pair of elevation frames.

One of the major embodiments includes a jetting mechanism which jets high-pressure water to the contact portion between the work and the cutting portion of the wire saw. In another embodiment, the tension mechanism includes ball screw means for adjusting a distance between any one of the sheaves and the arm.

According to still another aspect of the present invention, a wire saw machine which cuts a work by an endless wire saw, includes a plurality of sheaves for horizontally driving the wire saw, a drive mechanism for driving any of the sheaves, including a motor and a drive transmission mechanism for transmitting a driving force of the motor to the sheave, an elevation mechanism for elevating the plurality of sheaves, including a pair of column supports standing on a installation surface, a pair of elevation frames provided so as to move up and down with respect to the pair of column supports, respectively, a pair of arms which are fixed substantially horizontally along the rail direction to the elevation frames and each provided with at least one rotatable sheave, and elevation means for simultaneously elevating the pair of elevation frames, a tension mechanism for giving necessary tension to the wire saw, including ball screw means for adjusting a distance between any one of the sheaves and the arm, rails laid in a direction substantially orthogonal to a driving direction of the cutting portion of the wire saw, a carriage movable on the rails on which a work is set, a feed mechanism which feeds the carriage so that the work set on the carriage comes into contact with the cutting portion of the wire saw from the inside of a region formed by the wire saw laid across the sheaves, and a jetting mechanism which jets high-pressure water to the contact portion between the work and the cutting portion of the wire saw, wherein the work can be set on the carriage in an orientation such that the contact portion of the work with the cutting portion of the wire saw becomes small.

According to still another aspect of the present invention, a wire saw machine which cuts a work by an endless wire saw, includes a plurality of sheaves for horizontally driving the wire saw, a drive mechanism for driving any of the sheaves, including a motor and a drive transmission mechanism for transmitting a driving force of the motor to the sheaves, a pair of rails laid in a direction substantially orthogonal to a driving direction of a cutting portion of the wire saw, a pair of column supports movable on the pair of rails, an elevation mechanism for elevating the plurality of sheaves, including a pair of elevation frames provided so as to move up and down with respect to the pair of column supports, respectively, a pair of arms which are substantially fixed horizontally along the rail direction to the pair of elevation frames and each provided with at least one rotatable sheave, a tension mechanism for giving necessary tension to the wire saw, including ball screw means for adjusting a distance between any one of the sheaves and the arm, a feed mechanism which feeds the pair of column supports so that a work set between the pair of rails comes into contact with the cutting portion of the wire saw from the inside of a region formed by the wire saw laid across the sheaves, and a jetting mechanism for jetting high-pressure water to the contact portion between the work and the cutting portion of the wire saw, wherein the pair of rails are laid at an interval in which the work can be set in an orientation such that the contact portion of the work with the cutting portion of the wire saw becomes small. The above-described and other objects, features, and advantages of the present invention will be clarified from the following detailed description and the accompanying drawings.

### EFFECTS OF THE INVENTION

According to the present invention, an endless wire saw is horizontally driven by a plurality of sheaves and a drive mechanism for driving any of the sheaves, and the work is brought into contact with a cutting portion of the wire saw from the inside of a region formed by the wire saw laid across the sheaves. Therefore, when cutting, the wire smoothly bends in the same plane and the number of bends is small, so that the fatigue of the wire is reduced and durability is improved, and highly accurate cutting is realized with low horsepower. In addition, the contact portion between the work and the cutting portion of the wire saw is made small, so that the tension on the wire can be reduced and the wire breakage is reduced, and the cutting speed is improved and efficient cutting is realized. Furthermore, high-pressure water is supplied to the cutting portion, and this prevents production of dust, lowers the frictional heat, and lengthens the life of the wire.

### BRIEF DESCRIPTION OF THE DRAWINGS

FIG. 1 is a front view of a first embodiment of the present invention;

FIG. 2 is a plan view of the first embodiment;

FIG. 3 is a view of FIG. 2 observed from the arrow F1 direction;

FIG. 4 is a perspective view of a state of the main part when cutting according to the first embodiment;

FIG. 5 are drawings showing shapes of the wire in cutting, and FIG. 5(A) is an explanatory view of a state when cutting according to the present invention, and FIG. 5(B) is an explanatory view of a state in cutting according to the background art;

FIG. 6 is a perspective view of a second embodiment of the present invention;

FIG. 7 is a plan view showing a third embodiment of the present invention and a modified example thereof; and

FIG. 8 is a plan view showing a fourth embodiment of the present invention and a modified example thereof.

### DESCRIPTION OF THE SYMBOLS

10: Wire saw

10A: Cutting portion

12, 14, 16, 18: Sheave

12A, 14A, 16A, 18A: Bearing

12B, 14B, 16B, 18B: Rotation shaft

20, 22: Elevation frame

24, 26: Arm

28: Joint

30: Rotary motor

32: Rotation shaft

34, 38: V pulley

36: Belt

39: Belt transmission mechanism

40: Tension mechanism

42: Shaft

44: Turning plate

46: Nut

48: Ball screw

50: Handle

52: Bearing

54: Bead

60: Support frame

62, 64: Column support

66: Beam

68: Installation surface

69: Foundation

70: Transmission shaft

70A, 70B: Bevel gear

72A, 72B: Bearing

74: Elevation motor

76, 78: Feed screw

76A, 78A: Fixing member

76B, 78B: Bevel gear

80: Stone material

82: Carriage

82A: Slider

83: Front wheel

84: Rear wheel

85: Rail

86: Feed screw

88: Feed motor

90: Watering nozzle

100, 102: Movable base

104: Front wheel

106: Rear wheel

108A, 108B: Rail

110: Feed mechanism

120, 122, 130, 132, 134: Sheave

### BEST MODE FOR CARRYING OUT THE INVENTION

A large number of embodiments of the present invention are possible, however, an appropriate number of embodiments will be shown and described in detail herein.

### First Embodiment

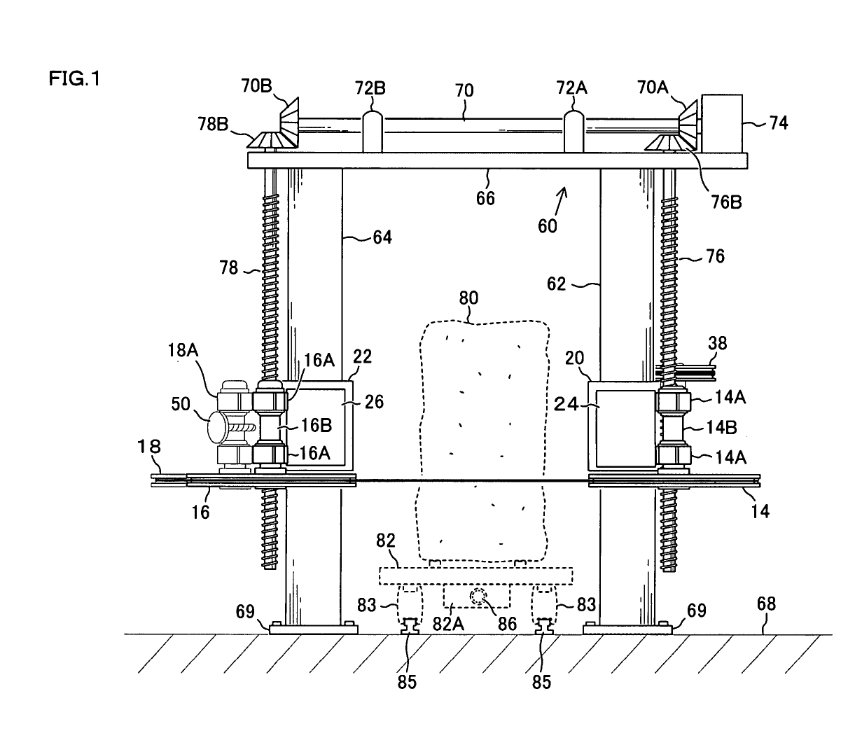

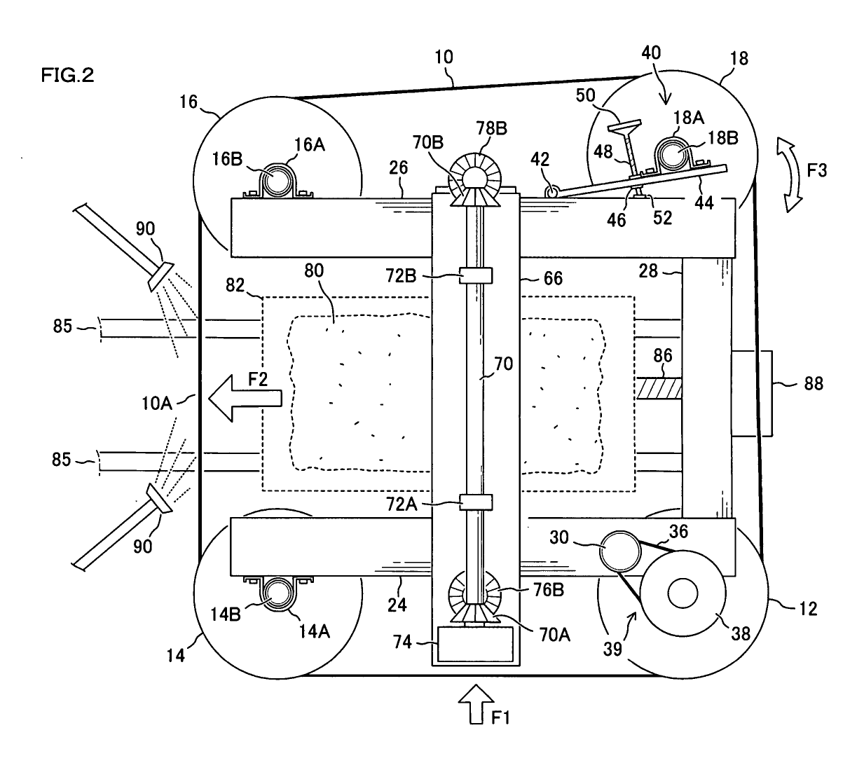

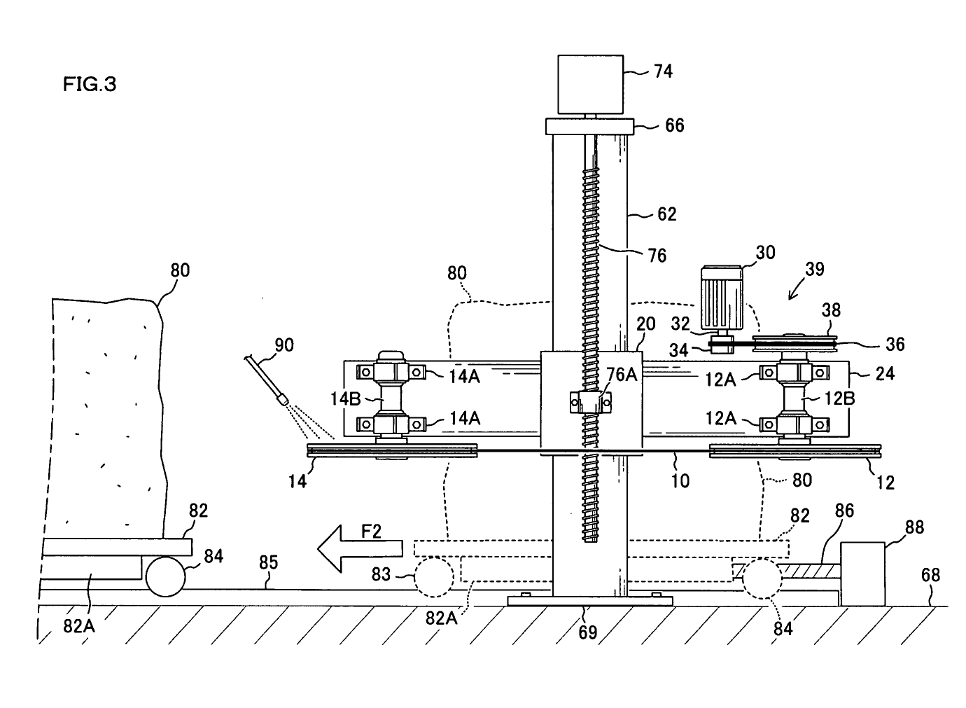

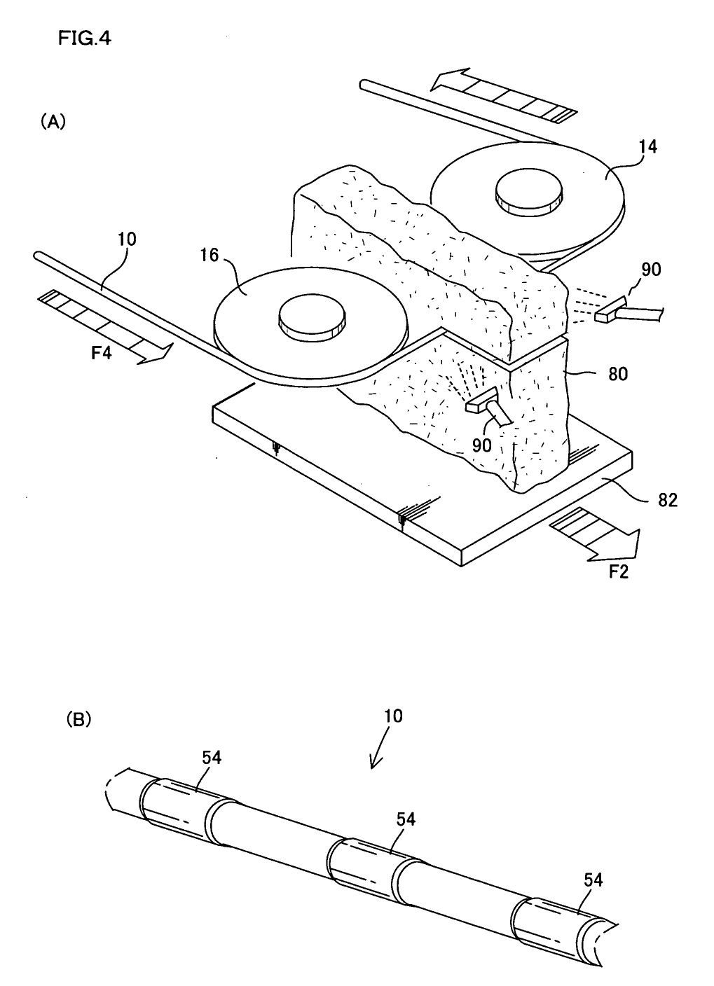

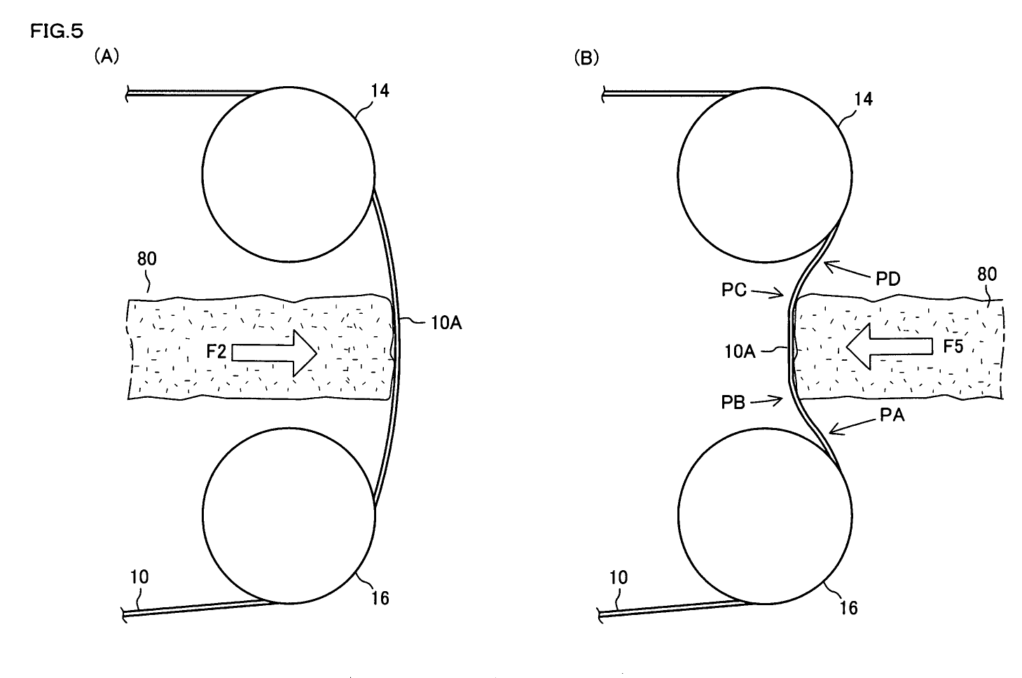

First, a first embodiment of the present invention will be described with reference to FIG. 1 through FIG. 5. FIG. 1 is a front view of the first embodiment. FIG. 2 is a plan view of the first embodiment, and a state thereof observed from the arrow F1 direction is shown in FIG. 3. FIG. 4(A) is a perspective view of a main part when cutting, FIG. 4(B) is a drawing showing a structure of a wire saw. FIG. 5 are drawings showing shapes of the wire when cutting, and FIG. 5(A) is an explanatory view of the state of the wire of the present invention and FIG. 5(B) is an explanatory view of the state of the wire according to the background art. This embodiment relates to a wire saw machine which horizontally cuts a work such as stone material. Other than stone materials, an arbitrary material such as wood may be set as a work by the wire saw machine of the present invention, however, in this embodiment, description is given by exemplifying a stone material as a work.

First, describing the entire constitution, the support frame 60 of the wire saw machine of this embodiment includes two column supports 62 and 64 and a beam 66 laid across the upper ends of the column supports, and is fixedly stood on the foundations 69 of concrete, etc., provided on an installation surface 68. Elevation frames 20 and 22 slidable up and down are provided on the column supports 62 and 64, and via arms 24 and 26 fixed to the elevation frames 20 and 22, sheaves 12, 14, 16, and 18 and the wire saw 10 move up and down. When a stone material 80 set on a carriage 82 that can travel on the rails 85 laid on the installation surface 68 comes into contact with a cutting portion 10A of the wire saw 10 from the inner side of a region (circle) formed by the wire saw 10, the stone material is cut. The respective parts will be described below in order.

As shown in FIG. 1 through FIG. 3, on the foundations 69 provided on the installation surface 68, the column supports 62 and 64 are fixedly stood, and provided with slidable elevation frames 20 and 22, respectively. On the other hand, on the beam 66, a transmission shaft 70 rotatably supported substantially parallel to the beam 66 by bearings 72A and 72B is provided, and on one end side of the beam 66 (right side of FIG. 1), an elevation motor 74 for rotating the transmission shaft 70 is fixed with appropriate means such as bolts. The rotation shaft of the elevation motor 74 is joined to the back side of a bevel gear 70A provided on one end side of the transmission shaft 70 so as to rotate the transmission shaft 70.

In both ends of the beam 66, bearings that are not shown are embedded, and feed screws 76 and 78 rotatably penetrating the bearings are provided substantially parallel to the column supports 62 and 64. These feed screws 76 and 78 are screwed with fixing members 76A and 78A provided on the side surfaces of the elevation frames 20 and 22, and thereby, the elevation frames 20 and 22 are attached so as to move up and down with respect to the feed screws 76 and 78. On the upper ends of the feed screws 76 and 78, bevel gears 76B and 78B which engage with the bevel gears 70A and 70B provided on both ends of the transmission shaft 70 are provided, and by a gear mechanism formed by engagement of these bevel gears, the rotation of the elevation motor 74 is simultaneously transmitted to the feed screws 76 and 78 via the transmission shaft 70. Namely, by driving and rotating the feed screws 76 and 78 by the elevation motor 74, the elevation frames 20 and 22 screwed with these feed screws 76 and 78 can simultaneously move up and down with respect to the column supports 62 and 64. As the feed screws 76 and 78, for example, square screws, etc., are used.

To the elevation frames 20 and 22 described above, arms 24 and 26 extending along the transferring direction of the stone material 80 are attached substantially horizontally, and one-side ends facing each other of the arms 24 and 26 (right side of FIG. 1) are joined to a joint 28. On both end sides of one arm 24, sheaves 12 and 14 are provided, and on both end sides of the other arm 26, sheaves 16 and 18 are provided. The endless wire saw 10 for stone material cutting is laid across the sheaves 12, 14, 16, and 18 arranged at substantially the same horizontal positions. Among these sheaves 12 through 18, the sheaves 12 and 14 are rotatably attached to the arm 24 by the bearings 12A and 14A, and the sheave 16 is rotatably attached to the arm 26 by the bearing 16A. The sheave 18 is rotatably attached to the arm 26 via the bearing 18A and a tension mechanism 40 that will be described later. These sheaves 12 through 18 are arranged so that the stone material 80 can be set on the inner side of the sheaves 12 through 18. In particular, in this embodiment, the sheaves 12 through 18 are arranged so that the stone material 80 can be set in an orientation such that the contact length between the stone material 80 and the cutting portion 10A of the wire saw 10, that is, the cutting width becomes short.

On the upper end face of the arm 24, i.e., near the bearing 12A of the sheave 12, a rotary motor 30 is provided, and a belt transmission mechanism 39 is provided between the rotation shaft 32 of this rotary motor 30 and the rotation shaft 12B of the sheave 12. The belt transmission mechanism 39 includes V pulleys 34 and 38 provided on the rotation shafts 32 and 12B and a belt 36. By this belt transmission mechanism 39, a rotary driving force of the rotary motor 30 is transmitted to the sheave 12, and the sheave 12 rotates. Then, when the sheave 12 rotates, the wire saw 10 also rotates. A gear transmission mechanism may be used instead of the belt transmission mechanism 39. It is also allowed that the rotation shaft 32 of the rotary motor 30 is directly connected to the rotation shaft 12B of the sheave 12 without interposition of the belt transmission mechanism 39. A speed control mechanism, etc., may be provided between the rotation shaft 32 of the rotary motor 30 and the rotation shaft 12B of the sheave 12.

On the side surface of the arm 26, i.e., near the bearing 18A of the sheave 18, a tension mechanism 40 is provided. As shown in FIG. 2, on the side surface of the arm 26, a turning plate 44 which can turn around the shaft 42 is provided. The above-described bearing 18A of the sheave 18 is provided near an open end of this turning plate 44. In substantially the center of the turning plate 44, a nut 46 is embedded. A ball screw 48 is provided so as to engage with this nut 46. On one end of this ball screw 48, a handle 50 is provided, and the other end is supported by a bearing 52. When the handle 50 is rotated, according to the rotating direction, the nut 46 moves on the ball screw 48. Then, the turning plate 44 moves in the arrow F3 direction, and furthermore, the sheave 18 moves in the arrow F3 direction. Due to this movement of the sheave 18 by the ball screw means, appropriate tension can be given to the wire saw 10.

Next, the stone material 80 to be cut is placed on a carriage 82 that can be accommodated within a region (or circle) formed by the wire saw 10 laid across the sheaves 12 through 18 as shown in FIG. 1 and FIG. 2. The carriage 82 is provided with front wheels 83 and rear wheels 84. On the other hand, along the above-described arms 24 and 26, a pair of rails 85 and 85 is provided parallel, and the front wheels 83 and the rear wheels 84 are laid on the rails 85. A feed screw 86 is provided along the rails 85, and one end thereof is joined to a feed motor 88. On the back side of the carriage 82, a slider 82A including a male screw that is screwed with the feed screw 86 is provided so that the carriage 82 travels on the rails 85 according to driving of the feed motor 88. Namely, the rails 85 are laid in a direction substantially orthogonal to the driving direction of the cutting portion 10A of the wire saw 10 so that cutting by the wire saw 10 is performed in the direction substantially orthogonal to the transferring direction of the stone material 80 on the carriage 82.

To the cutting portion 10A of the stone material 80 by the wire saw 10, high-pressure (for example, about 3 kg/cm²) water is supplied by a watering nozzle 90. The watering nozzle 90 prevents dust produced when cutting from scattering around and prevents the wire from being damaged by frictional heat. Normally, the wire saw 10 is structured so as to include beads 54 at appropriate intervals as shown in FIG. 4(B), and the beads 54 are made larger in diameter than other portions. If it is structured so that water is supplied to the cutting portion 10A due to free falling, in the case of horizontal cutting as in this embodiment, the stone material 80 is also present above the cutting portion, so that water hardly soaks into a desired cutting position. When one bead 54 passes through, soaking water is drained due to the bead 54, so that the next bead 54 passes a place without moisture. Therefore, dust scatters and the wire saw 10 is easily damaged by frictional heat. Therefore, as in this embodiment, by supplying water with a high pressure from the watering nozzle 90, water can be easily made to reach the cutting portion even in the case of horizontal cutting, so that dust scattering can be prevented and damage to the wire saw 10 due to frictional heat can be reduced.

Next, cutting operations according to this embodiment will be described in order. First, as shown in FIG. 1, the wire saw 10 is laid across the sheaves 12, 14, 16, and 18, and the handle 50 of the tension mechanism 40 is rotated to give appropriate tension to the wire saw 10. Then, by driving the elevation motor 74, the wire saw 10 is raised, and in a state that the carriage 82 is accommodated within a region formed by the wire saw 10, the stone material 80 is placed on the carriage 82. The stone material 80 is placed in an orientation such that the contact length with the cutting portion 10A of the wire saw 10, that is, the cutting width becomes short as described above. Then, by driving the elevation motor 74, the height of the cutting portion 10A is adjusted by elevation of the elevation frames 20 and 22 so that the cutting portion 10A comes into contact with a desired position of the stone material 80. Then, the sheave 12 is rotated by driving the rotary motor 30 to start rotating the wire saw 10, and high-pressure water is supplied by the watering nozzle 90. The wire saw 10 is rotated in, for example, the direction shown by the arrow F4 in FIG. 4(A), however, the wire saw 10 may be rotated in a reverse direction.

When the feed motor 88 is driven in this state, the carriage 82 moves on the rails 85 in the direction shown by the arrow F2 in the drawing. Then, as shown in FIG. 4(A) and FIG. 5(A), the cutting portion 10A of the wire saw 10 comes into contact with the stone material 80 and cutting of the stone material 80 is started. At this point in time, for example, as shown by the arrow F5 in FIG. 5(B), when the stone material 80 is brought into contact with the wire saw from the outside of the region formed by the wire saw 10, the wire saw 10 bends in unnatural directions at the positions PA, PB, PC, and PD, and the number of bends increases, so that the fatigue of the wire becomes remarkable and the wire becomes easy to be damaged. However, in this embodiment, as shown in FIG. 5(A), the stone material 80 comes into contact with the wire saw from the inner side of the region formed by the wire saw 10, so that the wire saw 10 smoothly bends within the same plane and includes no unnatural bends, so that the fatigue of the wire is very small. By thus moving the carriage 82 in the arrow F2 direction, the stone material 80 is accurately cut in a short period of time.

As described above, the first embodiment brings about the following effects.

(1) An endless wire saw 10 is horizontally driven by the sheaves 12 through 18, and the stone material 80 set on the carriage 82 is brought into contact with the cutting portion 10A from the inner side of the region formed by the wire saw 10 laid across the sheaves 12 through 18. Therefore, when cutting, the wire smoothly bends within the same plane, so that the fatigue of the wire 10 is reduced and the durability is improved, cutting is performed with high accuracy with a low horsepower, and the installation area can be reduced.

(2) The stone material 80 is set on the carriage 82 so as to reduce the contact portion between the stone material 80 and the cutting portion 10A of the wire saw 10, so that the cutting speed increases and efficient cutting is realized. In addition, the cutting width becomes small, so that the tension given to the wire can be reduced and breakage of the wire saw 10 can be reduced.

(3) High-pressure water is supplied to the cutting portion 10A by the watering nozzle 90, so that dust scattering is prevented, the frictional heat is lowered, and the life of the wire saw 10 can be further lengthened. In addition, due to application of the pressure, the amount of water to be used can be reduced and energy saving is realized.

### Second Embodiment

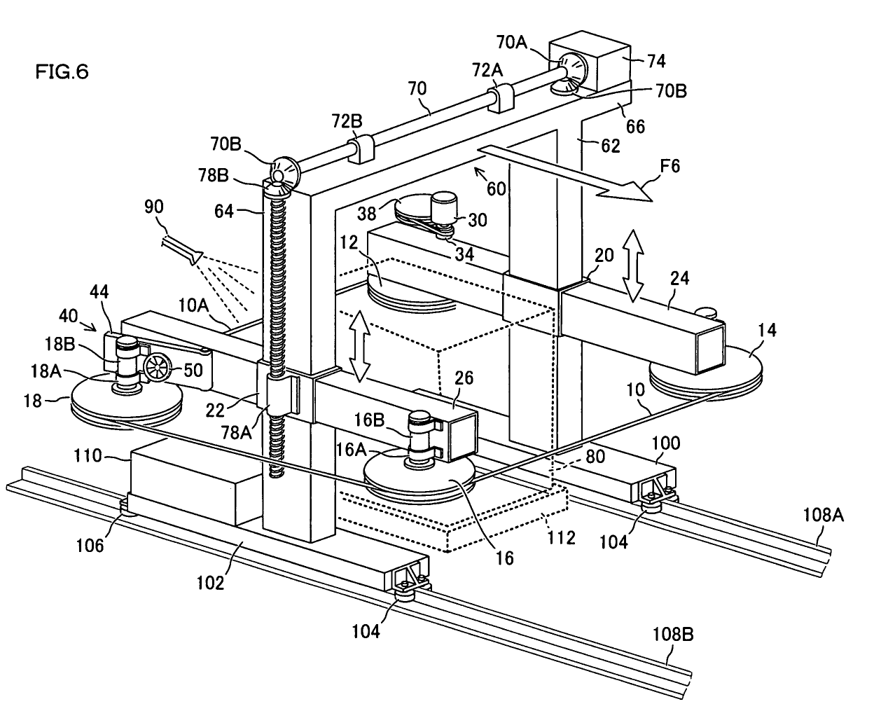

Next, a second embodiment of the present invention will be described with reference to FIG. 6. FIG. 6 is a perspective view of the second embodiment. For components identical or corresponding to those of the first embodiment, the same reference numerals are used (the same applies to the following embodiments). In the above-described first embodiment, the carriage on which the stone material 80 to be cut is set is made movable, however, in this second embodiment, the sheave side is made movable. In this embodiment, the two column supports 62 and 64 constituting the support frame 60 are fixed onto not the installation surface but movable bases 100 and 102, respectively. The movable bases 100 and 102 are provided substantially parallel along the pair of arms 24 and 26, and have front wheels 104 and rear wheels 106, respectively.

On the other hand, on the installation surface, a pair of rails 108A and 108 are provided parallel along the arms 24 and 26, and the front wheels 104 and the rear wheels 106 of the movable bases 100 and 102 are on the rails 108A and 108B. Namely, the rails 108A and 108B are laid in a direction substantially orthogonal to the driving direction of the wire saw 10. On one movable base 102, a feed mechanism 110 for enabling the movable base 102 to travel along the rail 108B is provided. As the feed mechanism 110, various known mechanisms can be applied such as a self-propelled type that drives the front wheels 104 or the rear wheels 106 by a motor. The stone material 80 to be cut is placed on a base 112 provided on the installation surface. The constitutions of other parts are the same as in the above-described first embodiment. In this embodiment, the support frame 60 is moved in the direction shown by the arrow F6 of FIG. 6 by the feed mechanism 110, so that the cutting portion 10A becomes a portion laid between the sheave 12 and the sheave 18.

Next, cutting operations according to the second embodiment will be described in order. First, in the same manner as in the above-described first embodiment, the wire saw 10 is laid across the sheaves 12 through 18, and appropriate tension is given to the wire saw 10 by the tension mechanism 40. By driving the elevation motor 74, the wire saw 10 is raised, and in a state that the base 112 is accommodated within the region formed by the wire saw 10, the stone material 80 is placed on this base 112. Also in this embodiment, the stone material 80 is placed in an orientation such that the contact length thereof with the cutting portion 10A of the wire saw 10, that is, the cutting width becomes short. Then, by adjusting the height of the cutting portion 10A by elevating the elevation frames 20 and 22 by driving the elevation motor 74 the cutting portion 10A comes into contact with a desired position of the stone material 80. Then, by driving the rotary motor 30, the sheave 12 is rotated to start rotating the wire saw 10, and high-pressure water is supplied by the watering nozzle 90.

When the feed mechanism 110 is driven in this state, the movable base 102 moves on the rail 108B in the direction shown by the arrow F6 of FIG. 6. Namely, the entirety of the support frame 60 moves in the direction shown by the arrow F6. Then, the cutting portion 10A of the wire saw 10 comes into contact with the stone material 80 set on the base 112 from the outer side. In other words, in the same manner as in the above-described first embodiment (see FIG. 4(A)), cutting is started when the stone material 80 is brought into contact with the cutting portion 10A from the inner side of the region (circle) formed by the wire saw 10. The effects to be brought about according to the contact of the stone material 80 from the inner side of the region formed by the wire saw 10, the size reduction of the contact portion with the cutting portion 10A, and provision of the watering nozzle 90 are the same as those in the above-described first embodiment.

### Third Embodiment

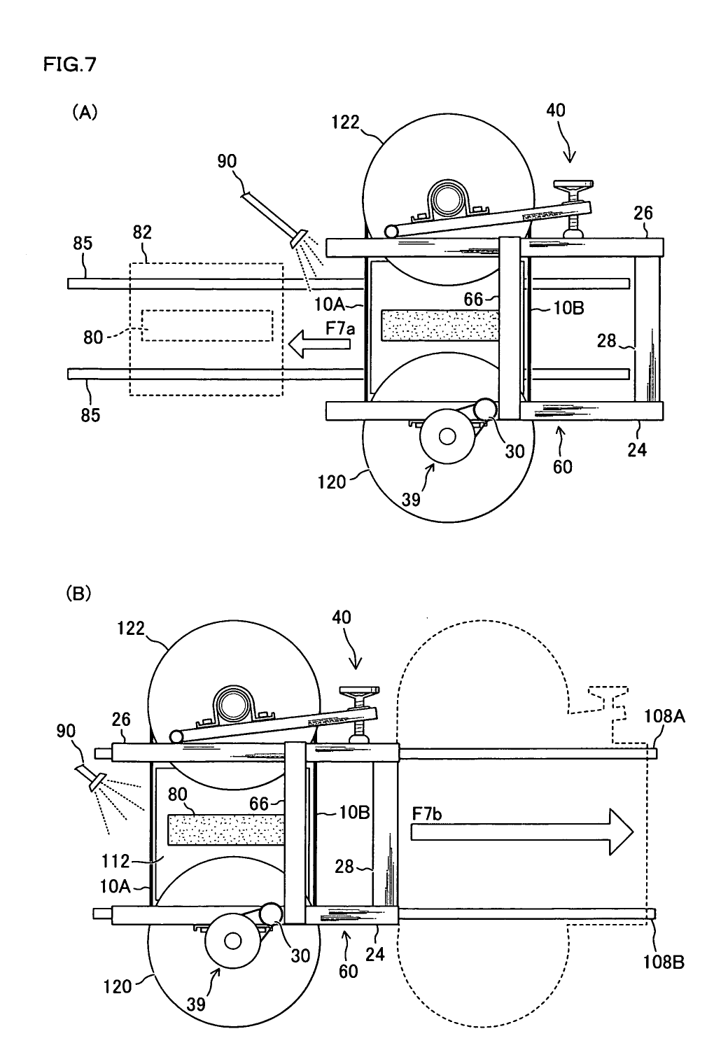

Next, a third embodiment of the present invention will be described with reference to FIG. 7. FIG. 7(A) is a plan view of this embodiment, and FIG. 7(B) is a plan view of a modified example of this embodiment. In the above-described first and second embodiments, four sheaves are used, however, in this embodiment, as shown in FIG. 7, two sheaves 120 and 122 are used. The sheave 120 is provided on the arm 24, and the sheave 122 is provided on the arm 26. First, in the example shown in FIG. 7(A), in the same manner as in the first embodiment, the stone material 80 is set on the carriage 82 which can travel in the direction shown by the arrow F7a on the pair of rails 85. On the sheave 120 side, a driving motor 30 and a belt transmission mechanism 39 are provided, and on the sheave 122 side, a tension mechanism 40 is provided. The diameters of the sheaves 120 and 122 are set so that the interval between cutting portions 10A and 10B of the wire saw 10 becomes wider than the width of the stone material 80. This is for preventing the stone material 80 from being cut by the rear cutting portion 10B when the stone material 80 is moved toward the cutting portion 10A from the inner side of the region formed by the wire saw 10. Other constitutions and effects are the same as those in the above-described first embodiment.

In the example shown in FIG. 7(B), in the same manner as in the above-described second embodiment, the side of the sheaves 120 and 122 moves. Namely, the support frame 60 can travel in the direction shown by the arrow F7b in the drawing on the pair of rails 108A and 108B provided parallel on the installation surface, and the cutting portion 10A is brought into contact with the stone material 80 from the outer side of the stone material 80 to be cut. The diameters of the two sheaves 120 and 122 are set similarly to those in the example shown in FIG. 7(A). Other constitutions and effects of this example are the same as those of the above-described second embodiment.

### Fourth Embodiment

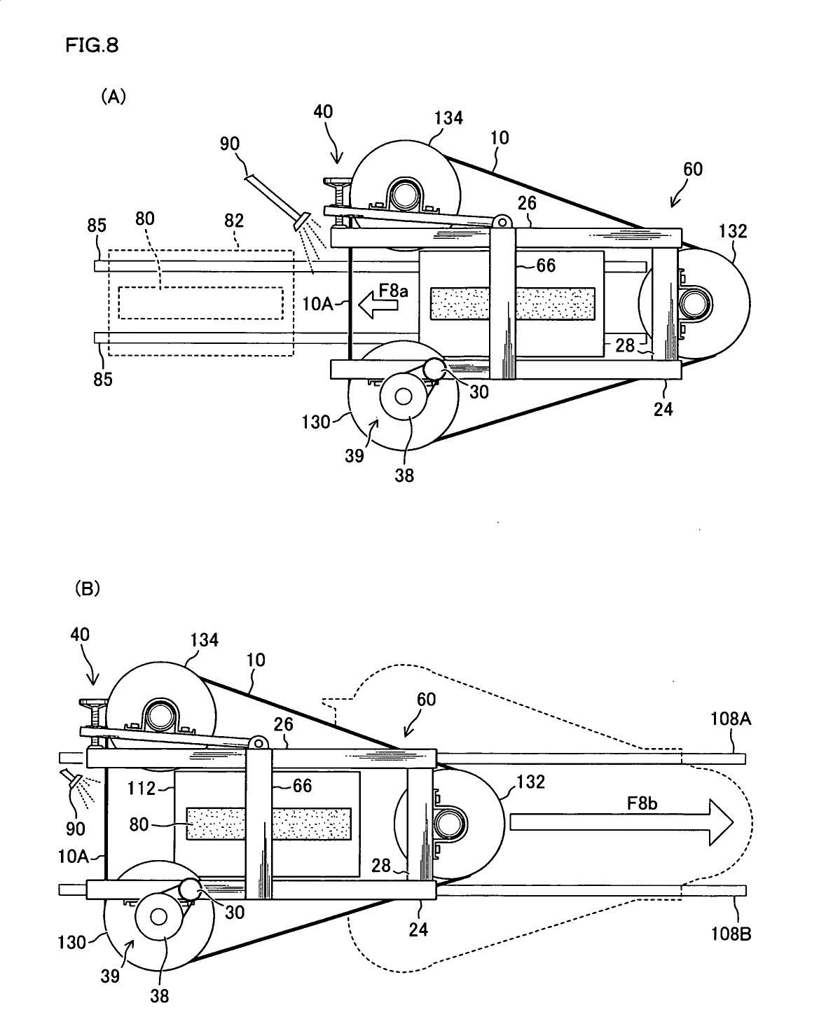

Next, a fourth embodiment of the present invention will be described with reference to FIG. 8. FIG. 8(A) is a plan view of this embodiment, and FIG. 8(B) is a plan view showing a modified example of this embodiment. In this embodiment, as shown in FIG. 8, three sheaves 130, 132, and 134 are used. First, in the example shown in FIG. 8(A), the carriage 82 on which the stone material 80 is set can travel in the direction shown by the arrow F8a on the pair of rails 85. The sheaves 130 through 134 are provided one by one on the arms 24 and 26 and the joint 28, respectively. On the sheave 130 side, a driving motor 30 and a belt transmission mechanism 39 are provided, and on the sheave 134 side, a tension mechanism 40 is provided. Other constitutions and effects are the same as those in the above-described first embodiment. The sheave 132 may be provided on the arm 24 or 26 side if the stone material 80 can be accommodated within the region formed by the wire saw 10.

In the example shown in FIG. 8(B), the support frame 60 supporting the sheaves 130, 132, and 134 can travel in the direction shown by the arrow F8b in the drawing on the pair of rails 108A and 108B provided parallel on the installation surface, and the cutting portion 10A is brought into contact with the stone material 80 from the outer side of the stone material to be cut. Other constitutions and effects of this example are the same as those in the above-described second embodiment.

The present invention includes a large number of other embodiments, and can be variously altered based on the above-described disclosure. For example, the following embodiments are also included.

(1) The shapes and sizes shown in the embodiments are examples, and they may be properly changed as appropriate. The number of sheaves shown in the embodiments is also an example, and the number of sheaves may be properly increased or reduced so as to bring about the same effects.

(2) In the above-described embodiments, the carriage 82 is made to travel by using the feed screw 86, however, it may use various other known mechanisms such as a self-propelled type which drives the front wheels 83 or the rear wheels 84 by a motor or wire means for drawing the carriage.

(3) In the above-described embodiments, the cutting position of the cutting portion 10A is adjusted by the elevation frames 20 and 22 that slide on the column supports 62 and 64, however, this mechanism is an example, and it may be properly changed so as to bring about the same effect. For example, the height of the stone material 80 is adjusted at the carriage 82 side.

(4) In the above-described embodiments, the sheaves are elevated with respect to a work, however, it is also allowed that the work is made elevated with the sheaves fixed. Namely, it is required that the sheaves are elevated relatively to the work, and this case is also included in the present invention.

(5) The present invention is applicable to cutting of various materials such as concrete and wood in addition to the above-described stone material 80.

### INDUSTRIAL APPLICABILITY

According to the present invention, by a plurality of sheaves and a drive mechanism which drives any of the sheaves, an endless wire saw is horizontally driven, and a work is brought into contact with a cutting portion of the wire saw from the inner side of a region formed by the wire saw laid across the sheaves. Therefore, the wire smoothly bends within the same plane when cutting, and the number of bends becomes small, so that it can be applied to a wire saw machine that cuts various works such as stone materials, concrete, or wood. In particular, the wire tension can be reduced by making the cutting width small, and furthermore, by supplying high-pressure water, friction and dust production at the cutting portion can be reduced, so that this wire saw is preferable as a wire saw machine with high durability.

1. A wire saw machine which cuts a work by an endless wire saw, comprising:
a plurality of sheaves for horizontally driving the wire saw;
a drive mechanism for driving any of the plurality of sheaves;
an elevation mechanism for elevating the sheaves;
a tension mechanism for giving necessary tension to the wire saw;
rails laid in a direction substantially orthogonal to a driving direction of a cutting portion of the wire saw;
a carriage on which a work is set and which is movable on the rails; and
a feed mechanism which feeds the carriage so that a work set on the carriage comes into contact with the cutting portion of the wire saw from an inner side of a region formed by the wire saw laid across the plurality of sheaves.

2. The wire saw machine according to claim 1, wherein on the carriage, the work can be set in an orientation such that a contact portion of the work with the cutting portion of the wire saw becomes small.

3. The wire saw machine according to claim 1, wherein
the elevation mechanism comprising:
a pair of column supports stood on an installation surface;
a pair of elevation frames provided on the pair of column supports, respectively, so as to move up and down;
a pair of arms which are fixed substantially horizontally along the rail direction to the pair of elevation frames, and each provided with at least one rotatable sheave; and
elevation means for simultaneously elevating the pair of elevation frames.

4. A wire saw machine which cuts a work by an endless wire saw, comprising:
a plurality of sheaves for horizontally driving the wire saw;
a drive mechanism for driving any of the sheaves;
a tension mechanism for giving necessary tension to the wire saw;
a pair of rails laid in a direction substantially orthogonal to a driving direction of a cutting portion of the wire saw;
a pair of column supports movable on the pair of rails;
an elevation mechanism for elevating the plurality of sheaves, provided on the pair of column supports; and
a feed mechanism for feeding the pair of column supports so that a work set between the pair of rails comes into contact with the cutting portion of the wire saw from an inner side of a region formed by the wire saw laid across the plurality of sheaves.

5. The wire saw machine according to claim 4, wherein the pair of rails are laid at an interval in which the work can be set in an orientation such that a contact portion of the work with the cutting portion of the wire saw becomes small.

6. The wire saw machine according to claim 4, wherein
the elevation mechanism comprising:
a pair of elevation frames provided on the pair of column supports, respectively, so as to move up and down;
a pair of arms which are fixed substantially horizontally along the rail direction to the pair of elevation frames and each provided with at least one rotatable sheave; and
elevation means for simultaneously elevating the pair of elevation frames.

7. A wire saw machine according to claim 1, further comprising:
a jetting mechanism for jetting high-pressure water to a contact portion between the work and the cutting portion of the wire saw.

8. The wire saw machine according to claim 3, wherein
the tension mechanism comprising:
ball screw means for adjusting a distance between any one of the sheaves and the arm.

9. A wire saw machine which cuts a work by an endless wire saw, comprising:
a plurality of sheaves for horizontally driving the wire saw;
a drive mechanism for driving any of the sheaves, including a motor and a drive transmission mechanism for transmitting a driving force of the motor to the sheave;
an elevation mechanism for elevating the plurality of sheaves, including a pair of column supports stood on an installation surface, a pair of elevation frames provided on the pair of column supports, respectively, so as to move up and down, a pair of arms which are fixed substantially horizontally along the rail direction to the elevation frames and each provided with at least one rotatable sheave, and elevating means for simultaneously elevating the pair of elevation frames;
a tension mechanism for giving necessary tension to the wire saw, including ball screw means for adjusting a distance between any one of the sheaves and the arm;
rails laid in a direction substantially orthogonal to a driving direction of a cutting portion of the wire saw;
a carriage on which a work can be set and which is movable on the rails;
a feed mechanism for feeding the carriage so that a work set on the carriage comes into contact with the cutting portion of the wire saw from an inner side of a region formed by the wire saw laid across the plurality of sheaves; and
a jetting mechanism for jetting high-pressure water to a contact portion between the work and the cutting portion of the wire saw, wherein
on the carriage, the work can be set in an orientation such that a contact portion of the work with the cutting portion of the wire saw becomes small.

10. A wire saw machine which cuts a work by an endless wire saw, comprising:
a plurality of sheaves for horizontally driving the wire saw;
a drive mechanism for driving any of the sheaves, including a motor and a drive transmission mechanism for transmitting a driving force of the motor to the sheave;
a pair of rails laid in a direction substantially orthogonal to a driving direction of a cutting portion of the wire saw;
a pair of column supports movable on the pair of rails;
an elevation mechanism for elevating the plurality of sheaves, including a pair of elevation frames provided on the pair of column supports, respectively, so as to move up and down, a pair of arms which are fixed substantially horizontally along the rail direction to the pair of elevation frames and each provided with at least one rotatable sheave, and elevating means for simultaneously elevating the pair of elevation frames;
a tension mechanism for giving necessary tension to the wire saw, including ball screw means for adjusting a distance between any one of the sheaves and the arm;
a feed mechanism for feeding the pair of column supports so that a work set between the pair of rails comes into contact with a cutting portion of the wire saw from an inner side of a region formed by the wire saw laid across the plurality of sheaves; and
a jetting mechanism for jetting high-pressure water to a contact portion between the work and the cutting portion of the wire saw, wherein
the pair of rails are set at an interval in which the work can be set in an orientation such that a contact portion of the work with the cutting portion of the wire saw becomes small.

11. The wire saw machine according to claim 2, wherein the elevation mechanism comprising:
a pair of column supports stood on an installation surface;
a pair of elevation frames provided on the pair of column supports, respectively, so as to move up and down;
a pair of arms which are fixed substantially horizontally along the rail direction to the pair of elevation frames, and each provided with at least one rotatable sheave; and
elevation means for simultaneously elevating the pair of elevation frames.

12. A wire saw machine according to claim 11, further comprising:
a jetting mechanism for jetting high-pressure water to a contact portion between the work and the cutting portion of the wire saw.

13. The wire saw machine according to claim 11, wherein the tension mechanism comprising:
ball screw means for adjusting a distance between any one of the sheaves and the arm.

14. The wire saw machine according to claim 5, wherein the elevation mechanism comprising:
a pair of elevation frames provided on the pair of column supports, respectively, so as to move up and down;
a pair of arms which are fixed substantially horizontally along the rail direction to the pair of elevation frames and each provided with at least one rotatable sheave; and
elevation means for simultaneously elevating the pair of elevation frames.

15. A wire saw machine according to claim 14, further comprising:
a jetting mechanism for jetting high-pressure water to a contact portion between the work and the cutting portion of the wire saw.

16. The wire saw machine according to claim 14, wherein the tension mechanism comprising:
ball screw means for adjusting a distance between any one of the sheaves and the arm.

17. A wire saw machine according claim 2, further comprising:
a jetting mechanism for jetting high-pressure water to a contact portion between the work and the cutting portion of the wire saw.

18. A wire saw machine according to claim 3, further comprising:
a jetting mechanism for jetting high-pressure water to a contact portion between the work and the cutting portion of the wire saw.

19. A wire saw machine according to claim 4, further comprising:
a jetting mechanism for jetting high-pressure water to a contact portion between the work and the cutting portion of the wire saw.

20. A wire saw machine according to claim 5, further comprising:
a jetting mechanism for jetting high-pressure water to a contact portion between the work and the cutting portion of the wire saw.

21. A wire saw machine according to claim 6, further comprising:
a jetting mechanism for jetting high-pressure water to a contact portion between the work and the cutting portion of the wire saw.

22. The wire saw machine according to claim 6, wherein the tension mechanism comprising:
ball screw means for adjusting a distance between any one of the sheaves and the arm.
